(19) United States
(12) Patent Application Publication
(10) Pub. No.: US 2012/0102088 A1
(43) Pub. Date: Apr. 26, 2012

(54) PRIORITIZED CLIENT-SERVER BACKUP SCHEDULING

(75) Inventors: Anuj Bindal, Bellevue, WA (US); Michael V. Sliger, Sammamish, WA (US); Guhan Suriyanarayanan, Redmond, WA (US)

(73) Assignee: Microsoft Corporation, Redmond, WA (US)

(21) Appl. No.: 12/909,854

(22) Filed: Oct. 22, 2010

(51) Int. Cl. G06F 15/16

(52) U.S. Cl. 709/203

(57) ABSTRACT

A prioritized backup time within a predetermined backup window can be calculated. The calculated backup time can be a time to initiate a backup operation to backup information from a client to a server. The calculation of the backup time can use a priority of the client and/or a degree of compliance of the client with a backup policy. An initiation of the backup operation by the client can be scheduled to occur at the calculated backup time, and the backup operation can be initiated. Other prioritized scheduling techniques can also be used, such as prioritized backup queue ordering, prioritized preemption of partially complete backup operations, and/or server override of the client's calculated backup time to begin a backup operation on demand.

### BACKGROUND

Information on clients is often backed up over a computer network to a backup server. In such schemes, a single server may be backing up many clients. These backups have been performed automatically during a backup time window within which backups to the server will be performed. In some such backup systems, each client that is to automatically backup to the server is aware of the backup window, and can initiate its backup within that window if the backup server is available (e.g., if the client is connected to a network that includes the backup server). For example, each client can choose a random time in the backup window for initiating its backup to avoid frequent collisions between backup initiation requests of different clients. The backup server can process the backup operations. For example, the server may maintain a queue of backup operations, which can operate on a first-in-first-out basis.

### SUMMARY

Whatever the advantages of previous tools and techniques for scheduling and performing backup operations, they have neither recognized the prioritized client-server backup scheduling tools and techniques described and claimed herein, nor the advantages produced by such tools and techniques. Prioritized scheduling of backup operations can be performed using various techniques and tools alone or in combination. This prioritized scheduling may assist in allocating backup operation resources (e.g., client time and server time) to more important backup operations and/or portions of backup operations. Importance of backup operations can be determined using various techniques, such by using client priority and/or client compliance with a backup policy. Examples of the tools and techniques can include prioritized calculation of a time for a client to initiate a backup within a backup time window, and/or prioritized backup operation management on a backup server.

In one embodiment, the tools and techniques can include calculating a prioritized backup time within a predetermined backup window to initiate a backup operation to backup information from a client to a server. The calculation of the backup time can use a priority of the client. This client priority is a representation of the client's priority in the backup scheme, which can represent how important it is for that client's data to be backed up. The client priority may be provided by a default value, by user input, or in some other manner. An initiation of the backup operation by the client can be scheduled to occur at the calculated backup time, and the backup operation can be initiated.

In another embodiment of the tools and techniques, a prioritized backup time can be calculated, where the backup time is a time to initiate a backup operation to backup information from a client to a server. The calculation may be performed by the client and it may use a degree of compliance of the client with a backup policy. The backup operation can be initiated from the client at the calculated backup time.

The degree of compliance with a backup policy indicates how closely the client is to complying with a backup policy. For example, a policy may indicate that each client is to be backed up once per day and the degree of compliance may indicate how many days it has been since the client has performed a successful backup operation. A backup policy may also indicate a threshold low level of policy compliance that will indicate that a client is out of compliance and trigger specified acts. For example, a client may attempt to trigger a backup outside the backup window if it has been seven days or more since the client successfully backed up. Many other backup policies can be used, such as policies with different time periods between backups (backing up once per hour, backing up once per week, backing up at different variable backup periods, backing up upon specified events (e.g., when a logoff event occurs), etc.), different out-of-compliance thresholds, no out-of-compliance thresholds, etc.

In yet another embodiment of the tools and techniques, a request to perform a first backup operation can be received. At a checkpoint in the backup operation while the first backup operation is being performed, it can be determined whether another available backup operation has a higher importance than a portion of the first backup operation that remains to be performed. For example, this determination may be done by comparing an importance of the whole first backup operation with the other available backup operations. If so, then the other backup operation can be performed before continuing with performing the remaining portion of the first backup operation. If not, then performance of the remaining portion of the first backup operation can continue.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a block diagram of a client-server backup scheduling environment or system.

FIG. 3 is a flowchart of a prioritized client-server backup scheduling technique.

FIG. 4 is a flowchart of another prioritized client-server backup scheduling technique.

FIG. 5 is a flowchart of yet another prioritized client-server backup scheduling technique.

### DETAILED DESCRIPTION

Embodiments described herein are directed to techniques and tools for improved scheduling of backup operations to a backup server. Such improvements may result from the use of various techniques and tools separately or in combination.

Such techniques and tools may include prioritized calculation of a time for a client to initiate a backup within a backup time window, and/or prioritized backup operation management on a backup server. For example, the prioritized time calculation may use a degree of compliance of the client with a backup policy and/or a priority of the client to define a time range within the window, as well as using a random number generation technique to choose a backup time within the time range. A client may periodically recalculate the backup time, and the backup time calculation may be done even when the server is not reachable when the calculation (e.g., recalculation) of the backup time is performed. Prioritized backup operation management may include ordering a backup queue on the server according to importance of backup operations waiting to be performed. For example, this may include ordering backup operations according to priority of clients being backed up by those operations (higher priority coming first), and if one or more of those priorities is the same, then ordering the operations according to a degree of compliance with a backup policy (lower level of compliance coming first). Prioritized backup operation management may include a server overriding a client's calculated backup time by contacting the client earlier and requesting that the client's backup operation be initiated at a time other than the client's calculated time, such as at another time when the server is idle or only has less important backup operations waiting to be processed. For example, a backup server may perform this override if it has an open channel to the client for the more important backup operation or if the server can wake the client from sleep with a wake-on-LAN command. As another example, prioritized backup operation management may include preempting a remaining portion of a backup operation to perform another more important backup operation.

One or more substantial benefits can be realized from the prioritized backup scheduling tools and techniques described herein. For example, the tools and techniques may help the backup server to make better use of its time, even if the server is over-subscribed. For example, the backup server may not be able to perform all requested backups during a backup window (e.g., a window from 6:00 PM on one day until 9:00 AM on the following day). However, the tools and techniques described herein may help the backup server to make better use of its time by doing more important backup operations first and/or making use of times when the backup server would otherwise have been idle.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Techniques described herein with reference to flowcharts may be used with one or more of the systems described herein and/or with one or more other systems. For example, the various procedures described herein may be implemented with hardware or software, or a combination of both. Moreover, for the sake of simplicity, flowcharts may not show the various ways in which particular techniques can be used in conjunction with other techniques.

### I. Exemplary Computing Environment

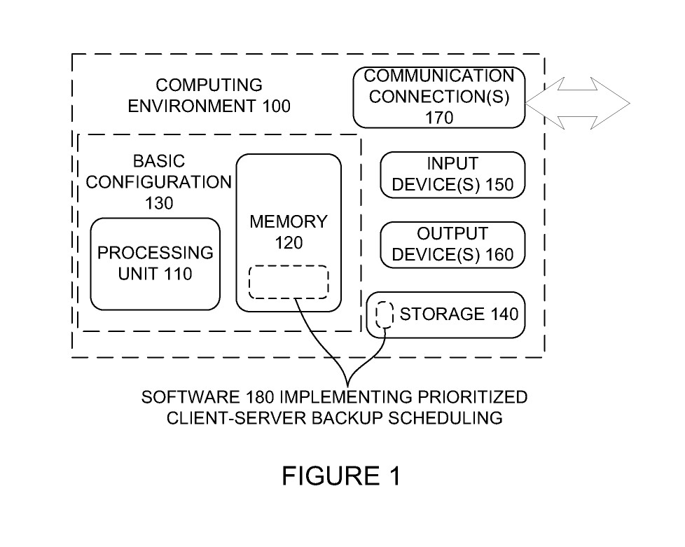

FIG. 1 illustrates a generalized example of a suitable computing environment (100) in which one or more of the described embodiments may be implemented. For example, one or more such computing environments can be used as a backup server and/or client. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing prioritized client-server backup scheduling.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media. Computer-readable media are any available media that can be accessed within a computing environment, and can include computer-readable storage media and communication media. By way of example, and not limitation, with the computing environment (100), computer-readable storage media include memory (120), storage (140), and combinations of the above. The term computer-readable storage media does not refer to signals per se.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Prioritized Client-Server Backup Scheduling System and Environment

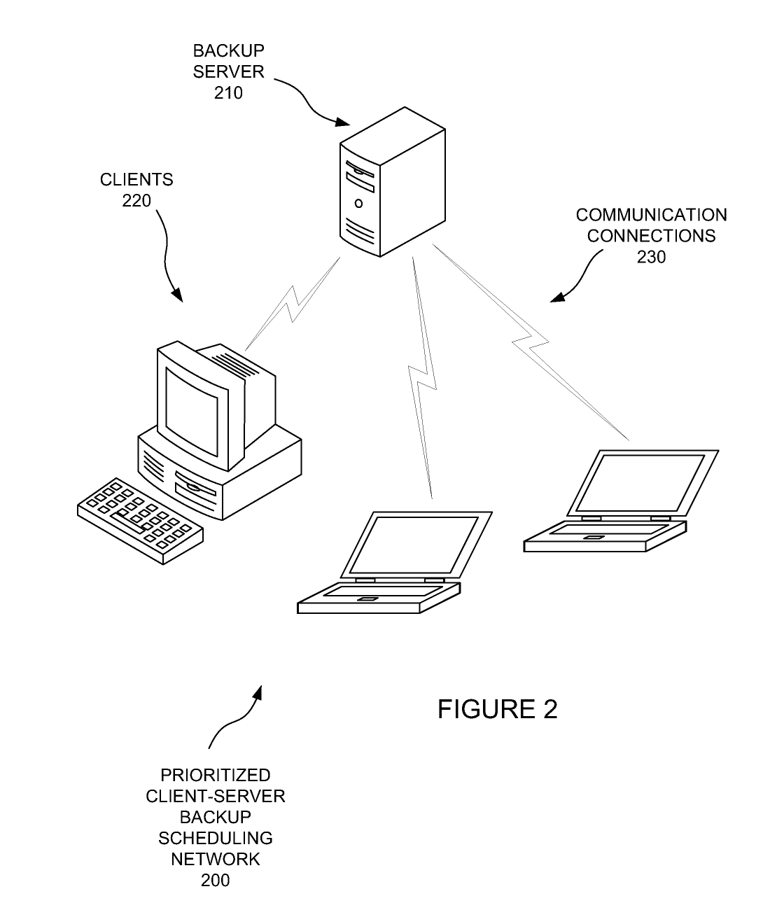

FIG. 2 is a block diagram of a prioritized client-server backup scheduling environment or system in conjunction with which one or more of the described embodiments may be implemented. The system can include a network (200), which can include a backup server (210) that is configured to perform backup operations for multiple clients (220) over communication connections (230). The server (210) and clients (220) can be configured in various ways. For example, each of the clients (220) may be running on a different physical machine, or multiple clients (220) may be running on one physical machine, such as in different virtual machines hosted by the same physical machine. The communication connections (230) may be any of various wired and/or wireless connections through which the clients (220) can communicate with the server (210), such as LAN connections or any of the other types of communication connections (170) discussed above.

In the network (200), the server (210) can be running continuously so that it can be reached by the clients (220) when the clients (220) are connected to the network (200). The clients (220) might be turned off or put to sleep to save power. Additionally, the clients (220) might be taken off the network (200) and connected to other networks where the server (210) is not reachable for extended periods of time.

Each of the clients (220) can initiate a network backup operation, where data from the client can be backed up to the server (210). Due to limited resource availability on the server (210), it may be difficult to schedule backups while still decreasing user intervention and impact; increasing the policy compliance of all clients on the network, and especially important clients; increasing the utilization of resources (e.g., reducing the time for which server is idle); and decreasing the time for which a client is on and awake for backup purposes. The tools and techniques described herein may achieve one or more of these items. For example, user impact may be decreased by reserving a user-configurable time window for running network backup operations (e.g., during evening and night-time hours). One or more of the other items may be achieved by prioritized scheduling of client-server backup operations to achieve greater compliance with a backup policy (e.g., with greater importance being given to more important clients), to increase utilization of the server's available time, and to decrease time that clients need to up to perform backup operations.

As will be described in more detail below, each of the clients (220) can determine its backup time based on its priority, degree of policy-compliance and backup window (which can be indicated by user input and can be the same for all clients (220) on the network (200)). Additionally, the server (210) may override this behavior for one or more of the clients (220) by starting a backup if the server (210) determines that a particular client's backup operation is the most important out of the currently available clients (e.g., available in a backup operation queue, available by being reachable by an open channel, and/or available by being reachable by a wake-on-LAN command). The server (210) may also perform a prioritized ordering of backup operations in the server's queue, so that backup operations determined to be more important get performed first. Additionally, the server (210) may preempt a remaining portion of a backup operation so that another more important backup operation can proceed first.

A. Prioritized Scheduling by Clients

As noted above, each of the clients (220) can calculate a backup time during a backup window. The backup time calculation can be based on the client's priority and on the client's degree of compliance with a backup policy. The backup time can be recalculated repeatedly by each of the clients (220). For example, the backup time recalculation may be performed periodically according to a schedule (e.g., once per day), and/or the backup time recalculation may be triggered by one or more events (e.g., as part of a logon process, as part of a logoff process, etc.). The clients (220) can make the calculations without communicating with the server (210) at the time of the calculations, so that a calculation can be made by one of the clients (220) even when the server (210) is unavailable to that client at the time of the calculation.

Consider an example where user input (or a default value) indicates that the backup window for the network (200) is between the times X and Y on a given day. Also, for this example, assume that a backup policy indicates that the clients (220) are to be backed up once every 24 hours.

Each of the clients (220) can be given a priority N, which gives a measure of relative importance of the client on the network (200). The priority N for each of the clients (220) can be provided by user input, such as user input from an administrator on the backup server (210), or the priority can be provided in some other manner, such as by an automated analysis using various factors (level of the client's users in a company, permissions of the client's users, business department of the client's users, characteristics of the client, etc.). For the example calculation technique described below, a lower number indicates higher priority and a higher number indicates a lower priority.

If a client is not backed up for D days, then D can be used as a measure of the degree of compliance of the client with the backup policy, where a lower value of D indicates a greater degree of compliance. The backup time of one of the clients (220) can be calculated using the client's priority and degree of compliance to determine a time range within the backup window (using Equations 1-2, as described below) and then generating a random backup time within that time range.

The time for the client to wake up and initiate a backup operation can be calculated by generating a random number to produce a random backup time in a time range that is the first Mth fraction of the backup window, where M is calculated according to Equation 1 below:

$$M = \frac{( N - \frac{D}{C} )}{N + 1} \qquad Equation 1$$

In Equation 1 above, C is a constant, which determines the ratio by which M is skewed in favor of a client as it goes out of compliance. If C is low then M is skewed faster, if it is high then M is skewed more slowly. C can also be configured based on the range of values N and D can take, so that M is a number between 0 and 1.

In order to get a meaningful value of M for the full ranges of N, D, and C, the values of N, D, and C can be constrained as follows in one implementation:
N: 1-5
D: 0 to 10 (If D>10, then D is set to 10.)
C: 6

For these values, M can generally be positive. If M turns out to be negative (e.g., if N=1 and D=10), then M can be marked as 0.

The backup time for the client can be computed by generating a random number between X and Z, where X is the beginning time of the backup window and Z is the end of the Mth fraction of the backup window, calculated according to Equation 2 below.

Z=(X+M(Y−X)) Equation 2

As N decreases (i.e. priority increases), Z comes closer to X so that clients (220) with higher priorities have a better chance of being backed up earlier in the backup window. If M is 0, then the client can be scheduled to backup at the beginning of the backup window. Thus, more important clients (220) can be biased toward the beginning of the backup window, also giving them a better chance of being backed up each day. For example, those of the clients (220) with data that is deemed to be business critical data can be assigned highest priority possible (N=1 in the example above) so that those clients (220) can be backed up earlier in the backup window. Additionally, as D increases, Z comes closer to X again, so that those of the clients (220) with a lower degree of compliance can be biased toward earlier backup times.

Note that with the constraints above M does not reach 1, so that clients (220) are not scheduled at the end of the window and there will be some time left for the last client to complete its backup.

The clients (220) could calculate startup times in different ways. For example, clients (220) could use their degree of compliance without figuring in a priority for each of the clients (220). As an example, this could be done by using a constant value for N for all clients (220) in the network (200) and not allowing N to be changed for different clients (220), and still using equations 1 and 2 above. However, this would not account for different priorities of different clients (220) in the network (200). As another example, clients (220) could calculate a backup time without randomization. For example, clients could use the value of Z or some specified fraction of the value Z for their backup starting time. However, this could increase the chances of multiple clients (220) calculating the same backup start time, which could result in clients waiting longer and/or more often while the server (210) backed up other clients (220). Other variations in the calculation may also be used. Additionally, while the whole calculation can be performed on the clients (220), at least a portion of it may be performed on the server (210).

B. Prioritized Ordering of the Server Queue

Even if the clients (220) schedule backup times and then initiate backup operations at those scheduled times, a number of clients (220) can be queued on the server (210) at one time waiting for backup. To improve the chance of higher priority and lower compliance clients (220) being backed up first, the server (210) can order the queue in an order of importance of the backup operations in the queue. Accordingly, the server (210) can dynamically pick up clients (220) with highest priority and lowest compliance from the queue first. For example, the server (210) can pick up the backup operation for the client with the highest priority. If two clients (220) with operations in the queue have the same priority, then the operation for the client with the lowest degree of compliance with the backup policy can be ordered first.

This prioritized ordering of the queue for the server (210) may be used along with other prioritized ordering. For example, manually initiated backup operations (those initiated in direct response to user input) can be ordered ahead of all automatically initiated backup operations. As another example, other types of server operations may be ordered ahead of or behind the backup operations in the server queue. As used herein, the server queue can refer generally to an ordering of operations relative to each other in the server (210), which may be implemented in various ways such as by using a data structure that indicates a single list of queue items and/or a more complex data structure that could indicate multiple queue lists ordered relative to each other. Accordingly, the server (210) may process different types of operations in various different orders, where the order may depend on the relative importance of the operations according to a set of rules. For example, backup operations may be postponed to finish some non-backup operations (e.g., restore operations). As another example, backup operations may be processed while non-backup operations (e.g., data compression and cleanup operations) wait in the queue. As yet another example, backup operations may be pre-empted, as discussed below, to do non-backup operations (e.g., restore operations). As yet another example, non-backup operations (e.g., data compression and cleanup operations) may be pre-empted to do backup operations. As yet another example, a video streaming from the server (210) can be prioritized/de-prioritized and ordered relative to a backup operation from one of the clients (220) to the server because both operations may compete for the same set of resources.

C. Server Override of Client-Calculated Backup Times

In order to keep the server (210) busy during a backup window, the server (210) can override the client-calculated backup times by itself initiating operations at times other than those calculated by the clients (220). For example, if no clients (220) are waiting to run backups at the current time and the server (210) is idle, the server (210) can initiate backups “on-demand” with available clients (220). As another example, when the server (210) has completed a backup operation for a client, the server (210) may initiate an on-demand backup for an available client that has a more important backup operation (e.g., higher priority and/or lower degree of policy compliance) than other clients with backup operations in the queue. For example, the server-initiated on-demand backups can be triggered from among the available clients that have not backed up in the current backup window, in the order of the client priority (with highest priority, e.g., lowest N value, first), and then in order of the degree of compliance (with lowest degree of compliance, e.g., highest D value, first) for clients (220) with the same priority. The server (210) may wait to perform this on-demand technique until a specified percentage of the backup window has expired. This waiting can allow high priority/extremely low compliance clients (220) to be able to backup up in the beginning of the window without being blocked by backup operations of clients that are typically on but have a low priority and/or high compliance. For example, the on-demand technique may be enabled only after 10% of the backup window has passed.

Clients (220) can be considered available to the server (210) if the clients (220) can be reached by the server (210) to begin backup operations. For example, clients (220) may be available for on-demand backups by being on the network (200) with an open channel to the server (210). As another example, clients (220) can be available of they are capable of being woken on LAN. For example, the server (210) can try sending wake-on-LAN messages to the clients in the order of client priority and degree of compliance.

D. Preemption of a Running and Queued Backups

To allow higher priority clients (220) and/or lower compliance clients (220) to backup without getting blocked by lower priority and/or higher compliance clients (220) that happened to start backing up first, a remaining portion of a running backup can be preempted by another available backup operation when the running backup operation is only partially complete.

1. Preemption at a Checkpoint

For example, the running backup operation can be preempted at a check point in the backup operation. If a running backup operation (first backup operation) is preempted by another backup operation (second backup operation) at a checkpoint, then the remainder of the first backup operation can be entered in the server queue to be performed at a later time. Such a checkpoint can occur when a partial backup has been completed, but there is still a portion of the backup operation to be performed. The checkpoint can include the backup server (210) determining whether another available client that has not backed up in the backup window has a more important backup operation (for a higher priority client and/or for a lower compliance client) to be performed. Such a client may be available in various ways, such as by having a backup operation in the server queue, by having an open channel to the server (210), and/or by being available to be woken on LAN. Performance of partial backups will now be discussed.

2. Partial Backups

Partial backups and checkpoints may be implemented in various ways. An example of a block based backup system will be discussed here. Another example could include a backup system that backs up files on a file-by-file basis instead of a block-by-block basis. In such backup systems, a partial backup can be performed by identifying a subset of the total files to backup, and then backing up the subset.

A block based backup system may perform a file system backup operation through several partial backup operations. Each partial backup operation may identify a subset of blocks of data to backup. The subset may be a portion of the entire set of blocks of data that may be backed up to create a copy of an original file system. After the partial backup operations are completed, they can be grouped together into a single backup that can be used to restore a file system.

A backup operation may begin by identifying the blocks of data within a storage device to backup. The blocks of data may be gathered from a master file table or other list of files. A partial backup operation may be performed by identifying a subset of the total set of blocks to backup, then backing up the subset. When the subset has completed backing up, a partial backup may be stored on a backup storage system.

The partial backup may be considered a completed backup, but because the partial backup does not contain all of the blocks to recreate the file system (e.g., all the file system or the portion of the file system to be backed up in the entire backup operation), the partial backup may be considered unusable for a restore operation. The partial backup may be used to indicate which blocks are backed up when a subsequent partial backup is performed. The partial backups may be successively performed until the entire file system has been backed up. When the final partial backup has successfully completed, the backup may be considered usable to restore the file system.

The backup system may operate on a snapshot of the file system. A snapshot may be a version of the file system as the file system was at a specific point of time. Some operating systems may have a function that allows a snapshot to be taken of an operating system so that backup operations, for example, may process the file system at a given state of time. While the backup operation processes the snapshot, the operating system may allow other processes to update and change the file system.

The backup system may perform iterative partial backups on the file system. In such an embodiment, the backup system may perform a partial backup on the file system, and a second partial backup may include blocks of data that have been changed since the previous backup operation. In such an embodiment, the final backup may include a later version of the file system than if the backup system were to back up a snapshot of the file system.

Some embodiments may change the size of the partial backup based on network performance, previous partial backup performance, network connections, or other factors. In such embodiments, the partial backups may be larger or smaller from one partial backup to the next.

The backup system may backup blocks of data from a storage device that contains the file system. A block of data may be a predefined segment of storage space. In many embodiments, the block of data may be the smallest unit of storage used by a storage device. For example, an operating system may store data in 4 KB blocks on a hard disk or other storage device. Each file in the file system may have one or more 4 KB blocks associated with the file. In some embodiments, a block of data may be a larger unit of storage than the minimum size segment addressable by the operating system. Other embodiments may have larger or smaller blocks of data.

The backup system may backup and restore a file system by respectively copying and restoring individual blocks of data on a physical storage based on the block's placement or location on the original storage device. A file system may be recreated by replacing each block of data in the same physical location on a storage system.

A block based backup system may be agnostic to the contents of the blocks of data. A usable file system may be recreated when all of the blocks of data are present and placed in their original locations, but the backup system may not organize the blocks of data according to the file system.

A block based backup system may use backup tables to identify how to recreate each backed up version of a file system. A backup table may contain a listing of each position within the original storage device and the identifier of each block of data stored in the position. By maintaining multiple backup tables and using a common database of backed up blocks of data, many versions or instances of a backed up file system may be maintained in a relatively small database. This is because many versions of a file system may contain a large amount of duplicate data.

The file system may be used to identify blocks of data to backup. Once the blocks of data are identified, the blocks may be backed up without regard to the files associated with the blocks.

The backup system may perform backups in several different manners. In one use, the backup system may backup the complete contents of a file system. For example, the backup system may backup a file system where there is no existing backup copy of the file system. In such an example, all of the data within the file system may be copied to a backup storage system and organized so that the original file system may be restored.

Many embodiments may allow a user or administrator to select files to include or exclude from a backup operation. For example, some backup systems may allow a user to exclude temporary files or to select only certain file types or portions of a file directory to backup.

The backup system may perform a backup operation in an incremental manner. An incremental backup may compare a previous backup to determine which files have changed since the last backup. The changed files may be analyzed to identify blocks of data that may have been changed. In some cases, the blocks may not have been changed. For example, a large file may be made up of many blocks of data. The file system may indicate that the file has changed but the change may be limited to a small number of blocks of data. The block based backup system may mark all of the blocks as ‘suspect changed’, and then analyze which blocks are not already backed up. Those blocks that are not already backed up may be copied to the backup storage system.

The backup system may perform partial backups as a process for achieving a full backup. The backup system may select a subset of blocks to backup, and perform a partial backup operation using the subset. If the partial backup fails for some reason, the partial backup may be re-tried.

A partial backup may be useful in situations where a network connection may be broken or other factors may cause a backup operation to fail. As discussed above, a partial backup operation allows a full backup operation to be broken into smaller segments so that in the event of a failure, only a small amount of time may be lost.

An example of such a situation may be a mobile device that may connect and disconnect to a network as a user travels. For example, a user may be connected to a home network, but may disconnect and move to a coffee shop and reestablish a connection. A backup operation may be operating when the device is connected to the network. A portion of the backup may be performed while the device is connected to the home network and other portions performed while connected at the coffee shop. Each partial backup may add to the data already backed up so that when the final partial backup is complete, the system may have a complete backup.

The partial backup may be determined by a threshold. The threshold may be defined in a number of blocks, quantity of data in the blocks, or some other measurement of the size of a partial backup. The threshold may be used to limit the amount of data performed during a partial backup operation. The threshold may be changed based on various factors, such as the success, failure, and/or speed of a previous partial backup operation.

E. Putting Clients Back to Sleep While Waiting to Perform Backup

The wake time for clients (220) when performing backup operations can be decreased by putting clients (220) to sleep while they are in wait state, and waking a client when all clients (220) queued before it are done. For example, this may include the server (210) predicting approximately when all clients (220) queued before a client will be done backing up. The approximate time of completion for each of the clients (220) can be computed using the historical backup times for each of the clients (220). For example, the server (210) can make this computation and communicate to each waiting client an expected backup start time. The waiting client can determine whether to back to sleep or continue waiting. For example, a waiting client may go back to sleep if the expected wait is more than a predetermined threshold wait time, or stay awake if the expected wait is more than the predetermined threshold wait time.

Waking up clients (220) after certain durations of time can be done by configuring the clients (220) to wake up automatically. Alternatively, the server (210) may provide the clients (220) with wake-on-LAN commands at the end of computed durations, or at times when the server is actually ready to perform the queued backup operation with the respective clients (220).

F. Backup Outside the Window for Out-of-Compliance Clients

One or more of the clients (220) may automatically initiate a backup operation outside the backup window if the degree of compliance of the client with a backup policy is sufficiently low. For example, the clients (220) may check for compliance with the backup policy once per day and at the end of each backup. If the degree of compliance is sufficiently low for a client, the noncompliant client may start a task that will initiate the backup when the backup server (210) is reachable and possibly when other conditions are met. For example, the task may run every two hours, and when the task finds that the backup server (210) is available and the client has been idle for at least a set amount of time (e.g., ten minutes), then the task can initiate the backup operation by contacting the server. As with other initiations by the clients (220), this can result in the backup operation beginning immediately if the backup server (210) is not busy, or it may result in the backup operation being queued behind one or more other operations (backup operations and/or other server operations) if the backup server (210) is busy.

III. Prioritized Client-Server Backup Scheduling Techniques

Several prioritized client-server backup scheduling techniques will now be discussed. Each of these techniques can be performed in a computing environment. For example, each technique may be performed in a computer system that includes at least one processor and a memory including instructions stored thereon that when executed by the at least one processor cause the at least one processor to perform the technique (a memory stores instructions (e.g., object code), and when the processor(s) execute(s) those instructions, the processor(s) perform(s) the technique). Similarly, one or more computer-readable storage media may have computer-executable instructions embodied thereon that, when executed by at least one processor, cause the at least one processor to perform the technique.

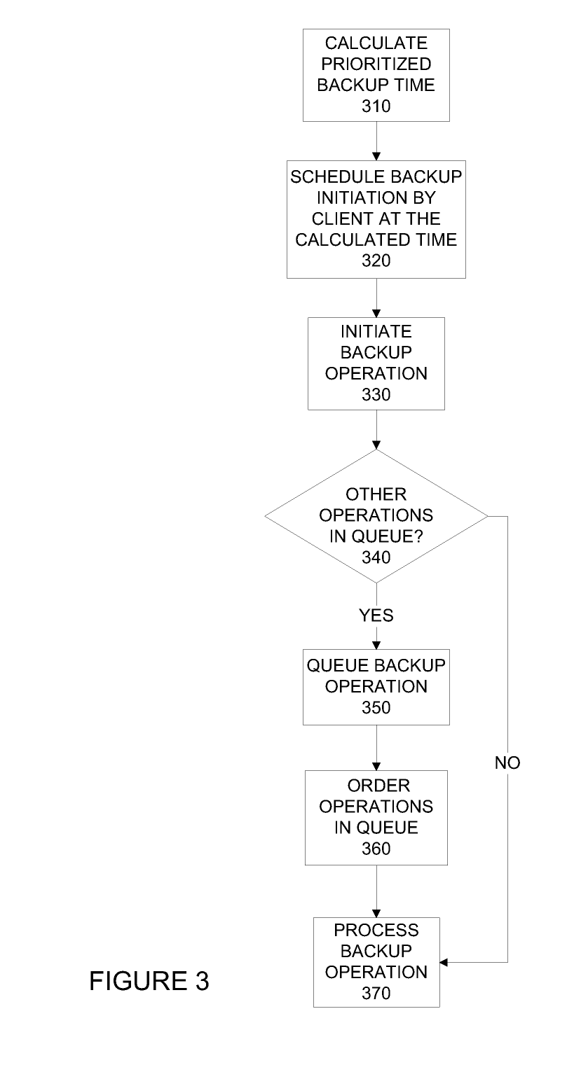

Referring to FIG. 3, a prioritized client-server backup scheduling technique will be discussed. The technique can include calculating (310) a prioritized backup time within a predetermined backup window to initiate a backup operation to backup information from a client to a server. The calculation (310) of the backup time can use a priority of the client. The calculation (310) of the backup time can be performed using a degree of compliance of the client with a backup policy, and the calculation (310) may be performed by the client without the client communicating with the server at the time of the calculation. Additionally, the calculation (310) can include repeated recalculations of the backup time. An initiation of the backup operation by the client can be scheduled (320) to occur at the calculated backup time. Additionally, the backup operation can be initiated (330).

Initiating (330) the backup operation may include initiating the backup operation from the client at the calculated backup time. Initiating (330) the backup operation may include overriding the calculated backup time to initiate the backup operation at an override time that is different from the calculated backup time. This overriding can be initiated by the server.

If a degree of compliance of the client with a backup policy is lower than a predetermined level and the client can initiate the backup operation outside the backup window, then initiating (330) the backup operation may include initiating the backup operation outside the backup window at a time other than the calculated backup time. A determination of whether the client can initiate the backup operation outside the backup window can include determining whether specified conditions are satisfied. For example, this determination may include determining whether the client is able to contact the backup server to initiate the backup, whether the client has been idle for a specified period of time, etc.

The technique of FIG. 3 can include multiple clients each calculating its own backup time to initiate a backup operation to backup information from that client to the backup server. Each calculation of a backup time for each client can include calculating a time within the backup window to initiate a backup operation. Each client can initiate the backup operation from the client at the calculated time.

The backup operation can be considered a “first” backup operation for the sake of clarifying this description. If it is determined (340) that the server also has one or more other backup operations in a server queue waiting to be performed when the first backup operation is initiated, then the technique can further include queuing (350) the first backup operation in the queue, ordering (360) the backup operations in the queue in a queue order, and processing (370) the first backup operation in turn in the queue order. If no other operations are in the queue, then the technique can include processing (370) the first backup operation. The queue order can be according to a priority of clients to be backed up by the backup operations, and also according to a degree of compliance with a backup policy for the clients to be backed up by the backup operations in the queue. Additionally, if the server also has one or more non-backup operations in the server queue waiting to be performed when the first backup operation is initiated, the technique can further include queuing the first backup operation in the server queue, ordering the first backup operation and the non-backup operations in the queue in a queue order, and processing the first backup operation in turn in the queue order with the non-backup operations and possibly with other backup operations in the queue. The technique of FIG. 3 may also include putting the client to sleep after queuing (350) the first backup operation while the client waits for the backup server to process at least a portion of one or more of the other backup operations in the queue, and then waking the client to perform the first backup operation.

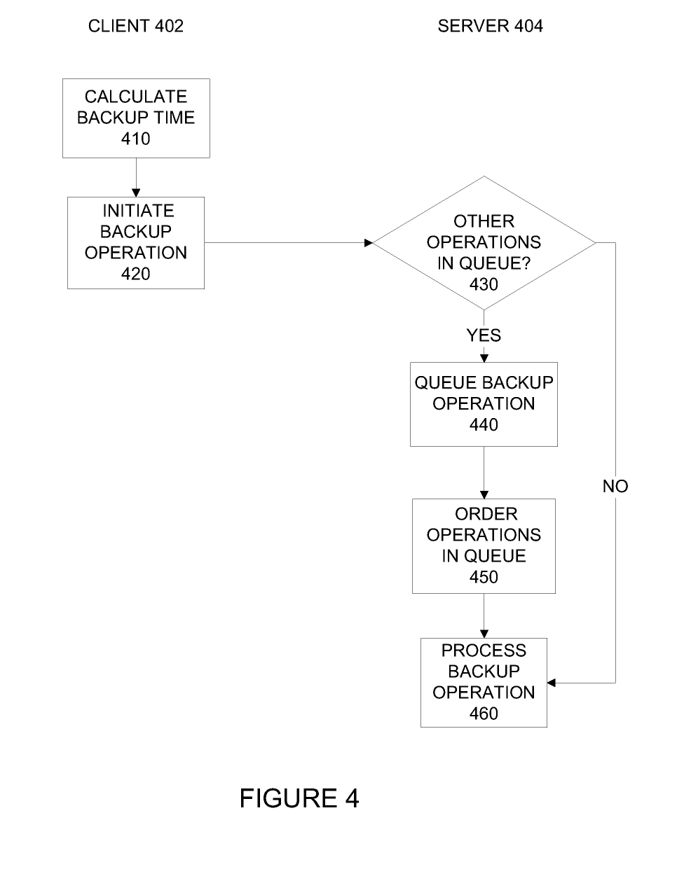

Referring to FIG. 4, another prioritized client-server backup scheduling technique will be discussed. The technique can include one or more acts to be performed by a client (402) (shown in a column below a heading for the client (402) in FIG. 4) and one or more acts to be performed by a server (404) (shown in a column below a heading for the server (404) in FIG. 4). The technique can include the client (402) calculating (410) a backup time to initiate a backup operation to backup information from the client (402) to the server (404). The calculation (410) can be performed by the client (402) (although the calculation can include information received from the server (404), such as a priority for the client (402), one or more constant values to be used in the calculation, etc.). The calculation (410) can use a degree of compliance of the client (402) with a backup policy, and may also use a priority of the client (402). The calculation (410) may also include a random number generation. Moreover, the calculation (410) can include repeatedly recalculating the prioritized backup time using updates to the degree of compliance of the client with the backup policy. Additionally, the technique can include the client (402) initiating (420) the backup operation from the client (402) at the calculated backup time, such as by the client (402) contacting the server (404) over a communication connection.

The backup operation may be considered a first backup operation for the sake of clarity in this description. The server (404) can determine (430) whether the server (404) has one or more other backup operations in a server queue when the backup operation is initiated. The server (404) can also queue (440) the first backup operation in the server queue, and order (450) the backup operations in the queue in a queue order. The queue order can be according to a priority of clients to be backed up by the backup operations. The queue order can also be according to a degree of compliance of the clients to be backed up by the backup operations in the queue with a backup policy. The server (404) can process (460) the first backup operation. While this processing (460) can be done whether or not other operations are in the server queue, the processing (460) can include processing the first backup operation in turn according to the queue order if the server (404) has one or more other backup operations in a server queue when the backup operation is initiated.

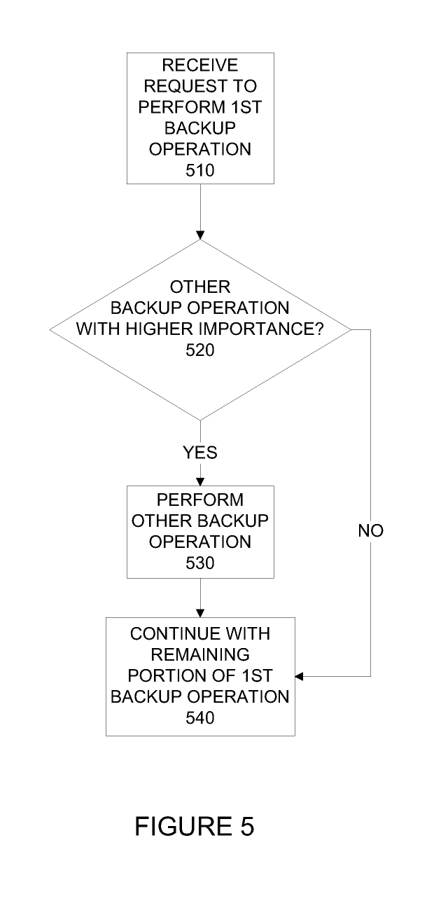

Referring to FIG. 5, yet another prioritized client-server backup scheduling technique will be discussed. The technique can include receiving (510) a request to perform a first backup operation. At a checkpoint in the backup operation while the backup operation is being performed, it can be determined (520) whether another available backup operation has a higher importance than a portion of the first backup operation that remains to be performed. If so, then the technique can include performing (530) the other backup operation before continuing (540) with performing the remaining portion of the first backup operation. If not, then the performance of the remaining portion of the first backup operation can be continued (540), and the continuing (540) may be done without waiting for other backup operations. Determining (520) whether another available backup operation has a higher importance can include one or more of the following: determining whether an open channel exists to a client to be backed up in a backup operation with a higher importance than the portion of the first backup operation; determining whether a sleeping client to be backed up in a backup operation with a higher importance than the portion of the first backup operation can be woken with a wake-on-LAN command; and determining whether another available backup operation has a higher importance includes determining whether a backup operation in a queue has a higher importance than the portion of the first backup operation. Additionally, the determination (520) can include determining whether the other backup operations have already been performed in the backup window, and considering backup operations to be unavailable if they have already been performed in the current backup window.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer-implemented method, comprising:
calculating a prioritized backup time within a predetermined backup window to initiate a backup operation to backup information from a client to a server, the calculation of the backup time using a priority of the client;
scheduling an initiation of the backup operation by the client to occur at the calculated backup time; and
initiating the backup operation.

2. The method of claim 1, wherein if a degree of compliance of the client with a backup policy is lower than a predetermined level and the client can initiate the backup operation outside the backup window, then initiating the backup operation includes initiating the backup operation outside the backup window at a time other than the calculated backup time.

3. The method of claim 1, wherein initiating the backup operation comprises initiating the backup operation from the client at the calculated backup time.

4. The method of claim 1, wherein initiating the backup operation comprises overriding the backup time to initiate the backup operation at an override time that is different from the calculated backup time, the overriding being initiated by the server.

5. The method of claim 1, wherein the method further comprises multiple clients each calculating its own backup time to initiate a backup operation to backup information from that client to the server, wherein each calculation of a backup time for each client comprises calculating a time within the backup window to initiate a backup operation.

6. The method of claim 1, wherein the calculation of the backup time is performed by the client without the client communicating with the server at the time of the calculation.

7. The method of claim 1, wherein the calculation of the backup time is performed using a degree of compliance of the client with a backup policy.

8. The method of claim 1, wherein the calculation of the backup time is performed by the client.

9. The method of claim 1, wherein the backup operation is a first backup operation and wherein if the server also has one or more other backup operations in a server queue waiting to be performed when the first backup operation is initiated, the method further comprises queuing the backup operation in the queue, ordering the backup operations in the queue in a queue order, and processing operations in the queue in the queue order.

10. The method of claim 9, wherein the queue order is according to a priority of clients to be backed up by the backup operations in the queue, and the queue order is also according to a degree of backup policy compliance of the clients to be backed up by the backup operations in the queue.

11. The method of claim 9, further comprising putting the client to sleep after queuing the first backup operation while the client waits for the server to process at least a portion of one or more of the other backup operations in the queue, and then waking the client to perform the first backup operation.

12. The method of claim 1, wherein:
initiating the backup operation comprises:
if the server decides to override the backup time, then overriding the backup time to initiate the backup operation at an override time that is different from the calculated backup time, the overriding being initiated by the server; and
if the server does not decide to override the backup time, then initiating the backup operation from the client at the calculated backup time;
the calculation of the backup time is performed by the client without the client communicating with the server at the time of the calculation;
the calculation of the backup time comprises repeated recalculations of the backup time, each of the repeated recalculations comprising:
using the priority of the client and a degree of compliance of the client with a backup policy to choose a time range that is a subset of the backup window; and
generating a random number to choose the backup time within the time range;
the backup operation is a first backup operation;
if the server also has one or more other backup operations in a server queue waiting to be performed when the first backup operation is initiated, the method further comprises queuing the first backup operation in the server queue, ordering the backup operations in the queue in a queue order, and processing the first backup operation in turn in the queue order, wherein the queue order is according to a priority of clients to be backed up by the backup operations in the queue and according to a degree of backup policy compliance of the clients to be backed up by the backup operations in the queue; and
if the server also has one or more non- backup operations in the server queue waiting to be performed when the first backup operation is initiated, the method further comprises queuing the first backup operation in the server queue, ordering the first backup operation and the non-backup operations in the queue in a queue order, and processing the first backup operation in turn in the queue order.

13. A computer system comprising:
a client comprising at least one client processor and a client memory having instructions stored thereon that when executed by the at least one client processor cause the at least one client processor to perform acts comprising:
calculating a prioritized backup time to initiate a backup operation to backup information from the client to a server, the calculation using a degree of compliance of the client with a backup policy; and
initiating the backup operation from the client at the calculated backup time.

14. The computer system of claim 13, wherein the calculation includes a random number generation and uses a priority of the client and the degree of compliance of the client with the backup policy.

15. The computer system of claim 13, wherein calculating the prioritized backup time comprises repeatedly recalculating the prioritized backup time using updates to the degree of compliance of the client with the backup policy.

16. The computer system of claim 13, wherein the backup operation is a first backup operation and the computer system further comprises the server, the server comprising at least one server processor and a server memory having instructions stored thereon that when executed by the at least one server processor cause the at least one server processor to perform acts comprising:
determining whether the server has one or more other backup operations in a server queue when the first backup operation is initiated, and if so then:
queuing the first backup operation in the server queue; and
ordering the backup operations in the queue in a queue order, wherein the queue order is according to a priority of clients to be backed up by the backup operations and according to a degree of backup policy compliance of the clients to be backed up by the backup operations in the queue; and
processing the first backup operation, wherein processing the first backup operation comprises processing the first backup operation in turn according to the queue order if the server has one or more other backup operations in the server queue when the first backup operation is initiated.

17. One or more computer-readable storage media having computer-executable instructions embodied thereon that, when executed by at least one processor, cause the at least one processor to perform acts comprising:
receiving a request to perform a first backup operation;
at a checkpoint in the first backup operation while the backup operation is being performed, determining whether another available backup operation has a higher importance than a portion of the first backup operation that remains to be performed;
if it is determined that another available backup operation has a higher importance than the remaining portion of the first backup operation, then performing the other backup operation before continuing with performing the remaining portion of the first backup operation; and
if it is not determined that another available backup operation has a higher importance than the remaining portion of the first backup operation, then continuing with performing the remaining portion of the first backup operation.

18. The one or more computer-readable storage media of claim 17, wherein determining whether another available backup operation has a higher importance includes determining whether an open channel exists to a client to be backed up in a backup operation with a higher importance than the portion of the first backup operation.

19. The one or more computer-readable storage media of claim 17, wherein determining whether another available backup operation has a higher importance includes determining whether a sleeping client to be backed up in a backup operation with a higher importance than the portion of the first backup operation can be woken with a wake-on-LAN command.

20. The one or more computer-readable storage media of claim 17, wherein determining whether another available backup operation has a higher importance includes determining whether a backup operation in a queue has a higher importance than the portion of the first backup operation.
